(19) United States
(12) Patent Application Publication
(10) Pub. No.: US 2006/0011176 A1
(43) Pub. Date: Jan. 19, 2006

(54) IR fuel activation with cobalt oxide

(76) Inventor: Albert Chin-Tang Wey, Westmont, IL (US)

Correspondence Address: Albert C. Wey, 233 E. 57th Street, Westmont, IL, 60559-2080, US

(21) Appl. No.: 10/892,772

(22) Filed: Jul. 16, 2004

(51) Int. Cl. F02M 27/00

(52) U.S. Cl. 123/538

(57) ABSTRACT

This invention relates to an infrared (IR) fuel activation device consisting of an infrared emitting body composed of selective metal oxides comprising at least 0.2 wt. % (weight percent) of cobalt oxide (CoO) that provides enhanced combustion of fuels in internal combustion engines, resulting in better engine performance with increased power, improved fuel economy, and reduced emissions.

### BACKGROUND ——FIELD OF INVENTION

This invention relates to an infrared (IR) fuel activation device consisting of an infrared emitting body composed of selective metal oxides comprising at least 0.2 wt. % (weight percent) of cobalt oxide (CoO) that provides enhanced combustion of fuels in internal combustion engines, resulting in better engine performance with increased power, improved fuel economy, and reduced emissions.

### BACKGROUND——DESCRIPTION OF PRIOR ART

The present inventor initiated a search for fuel efficiency improvement technology for internal combustion engines years ago and resulted in the inventions of fuel combustion enhancement devices using infrared radiation at the wavelengths 3-14 microns (U.S. Pat. Nos. 6,026,788 & 6,082,339).

These devices used an infrared emitting body composed of metal oxides selected from the group consisting alumina, silica, zirconia, lithium oxide, magnesium oxide, calcium oxide, titanium oxide, and so on. Although the devices of those inventions worked adequately, they were not optimized and left rooms for improvement. In fact, the emissions from aforementioned ceramic materials were measured to be strong at wavelengths in 8-14 microns, yet starting decreasing sharply toward wavelengths shorter than 7 microns, with a 3-dB cutoff point at around 5 microns. In other words, the emissions at 3-7 microns were very low with these compositions.

However, based on the theoretical studies conducted by the present inventor, the lower wavelength band at 3-7 microns would play a key role on IR-fuel activation, because the majority of valence bonds in hydrocarbon molecules of the fuels absorb IR radiation at low wavelengths to activate bond stretching, which can be summarized in Table 1.

TABLE 1
IR absorption caused bond stretching in hydrocarbons.

| Frequency (cm⁻¹) | Wavelength (μm) | Bond Structure |
|---|---|---|
| 1315-1475 | 6.78-7.60 | C—H (in alkanes) |
| 2800-3000 | 3.33-3.57 | C—H (in alkanes) |
| 1450-1600 | 6.25-6.90 | C═C bond in aromatic ring |
| 1620-1680 | 5.95-6.17 | C═C |
| 2100-2200 | 4.55-4.76 | C≡C |
| 3000-3100 | 3.23-3.33 | C—H (C is part of aromatic ring) |
| 3300 | 3.03 | C—H (C is acetylenic) |
| 3020-3080 | 3.25-3.31 | C—H (C is ethylenic) |

Besides, it is a well known fact that the higher the frequency (or the lower the wavelength) of a photon is, the higher the kinetic energy the photon has, as kinetic energy increases proportionally to the second power of frequency (or inversely to that of wavelength). The use of IR emissions at a lower wavelength band 3-7 microns would be much more desired and advantageous than that at 8-14 microns.

For example, absorbing IR radiation at wavelengths 3.23-3.33 and 6.25-6.90 microns helps energizing and loosening the C—H and C═C bonds in aromatic ring forms of hydrocarbons. These types of hydrocarbons usually have heavy heat contents that contribute to most of the power output of an engine. However, on the other hand, they have high burning points so that they may not be burnt until the late cycle, which accounts for the best part of unburnt HC and CO in exhaust emissions. After irradiating the fuels with IR radiation at 3-7 microns, it can energize aforementioned bonds so that they may require less heat energy to break up the bonds during oxidation (combustion) reaction and result in higher net energy for mechanical works. It can provide a more instantaneous and complete burning of these heavy heat-content components of the fuel, which will give rise to a more efficient combustion. Accordingly, the lack of emissions at 3-7 microns from the materials used in the quoted inventions would considerably undercut the effects of IR-Fuel Activation.

Thereby, the present inventor had undertaken extensive studies and continued the search for ceramic materials that might posses a strong radiation capacity at the desirable wavelengths 3-7 microns in order to fulfill the needs. Consequently, the present inventor experimentally discovered that adding more than 0.2 wt. % of cobalt oxide (CoO), currently used as pigment in paints and ceramic, to the aforementioned IR emitting oxides mixture could boost the IR radiation at the most wanted band of 3-7 microns. Furthermore, adding more than 0.5 wt. % of CoO could significantly increase the IR fuel activation effects.

The present inventor further found that replacing cobalt oxide with nickel oxide from the same group (Group 10 or VIIIA) might have similar but slightly less fuel activation effects. Cobalt (Co) has a Ground-State electron configuration [Ar]3 d⁷4s² while nickel (Ni) has [Ar]3d⁸4s². Co and Ni are located in Group 10 on the Periodic Table and are the second and third element in the special Group of the first series of transition metals. It is interesting to point out hereby that in early days evil spirits were thought to be represented in cobalt and nickel, both from German words for “goblin” (Nickel and Kobold), for the difficulties they caused in the extraction of copper (Cu) from its ores. Derived from experimental results, the present inventor had concluded that both cobalt oxide (CoO) and nickel oxide (NiO) could provide boost up on the much needed radiation strength at 3-7 micron wavelengths.

The use of cobalt oxide as one of possible IR emitting materials might have been briefly mentioned in prior art, however revealing neither its role on nor its contribution to the resultant IR emitting ceramics. For example, CoO was vaguely named along with MnO₂, FeO₂ and CuO that might be mixed with Kibushi-Nento (a clay) to form far infrared emitting bodies (U.S. Pat. No. 4,886,972). However, it gave no explanation on how and why CoO would contribute to the consequential far infrared radiation spectrum, which was 5-15 microns. Besides, the applications of such invention were suggested to be on food process, agricultures and health, not hinting on fuel activation for an internal combustion engine whatsoever.

Another device consisting of soft porous ancient marine humus was invented for the promotion of combustion in an internal combustion engine (U.S. Pat. No. 6,058,914). The marine humus used in this invention was analyzed to contain 0.06 wt. % of cobalt oxide, which essentially was just a negligible natural residue that happened to present in the humus.

Therefore, the prior art fails to teach a device that enables improving fuel combustion efficiency in an internal combustion engine comprising an infrared emitting body composed of a mixture of selective metal oxides containing at least certain weight percentage of cobalt oxides (CoO) with intention which can boost the needed infrared radiation at wavelengths 3-7 microns for energizing valence-bond stretching in hydrocarbon molecules of the fuels.

### OBJECTS AND ADVANTAGES

Accordingly, one object of this invention is to provide a device that can enhance combustion efficiency of hydrocarbons-based fuels in an internal combustion engine to better its performance for increased power, improved fuel economy, and reduced emissions.

Another object of the present invention is to provide a simple, easy-to-install, and maintenance-free fuel combustion efficiency enhancement device.

These objectives are achieved by an IR Fuel Activation device comprising essentially a housing and disposed within said housing an infrared emitting body that is formed of selected metal oxides containing at least 0.2 wt. % cobalt oxide (CoO). The device can be either inserted to the fuel line or mounted externally on the fuel line before the point where fuel flows into a carburetor of fuel injection system in order to energize the fuel before it enters the cylinders for combustion.

Other objects, features and advantages of the present invention will hereinafter become apparent to those skilled in the art from the following description.

### DRAWING FIGURES

FIG. 1 shows a cutaway perspective view of one embodiment of the present invention with an infrared emitting body consisting of multiple units in spherical form that will be in contact with the fuel flowing through the housing.

FIG. 2 shows a cutaway perspective view of one embodiment of the present invention with an infrared emitting body consisting of a spherical unit and in a tubular unit.

FIG. 3 shows a cutaway perspective view of one embodiment of the present invention infrared emitting body in an arbitrary form, being externally mounted to a fuel line.

### REFERENCE NUMERALS IN DRAWINGS

| | |
|---|---|
| 11 | Spherical infrared emitting unit |
| 12 | Tubular infrared emitting unit |
| 13 | Infrared emitting body in a arbitrary form |
| 21 | Metal Housing |
| 22 | Non-metal Housing |
| 31 | Rubber or plastic fuel line |

### SUMMARY

In accordance with the present invention an IR fuel activating device consists of a housing and an infrared emitting body composed of selective metal oxides comprising at least 0.2 wt % cobalt oxide to boost IR emissions at 3-7 microns. I can provide enhanced combustion of fuels in internal combustion engines, resulting in better engine performance with increased power, improved fuel economy, and reduced emissions. The IR Fuel Activation device can be either inserted to a fuel line or externally mounted on a non-metal section of a fuel line at a point before the fuel enters the carburetor or fuel injection system.

### DETAILED DESCRIPTION OF THE INVENTION

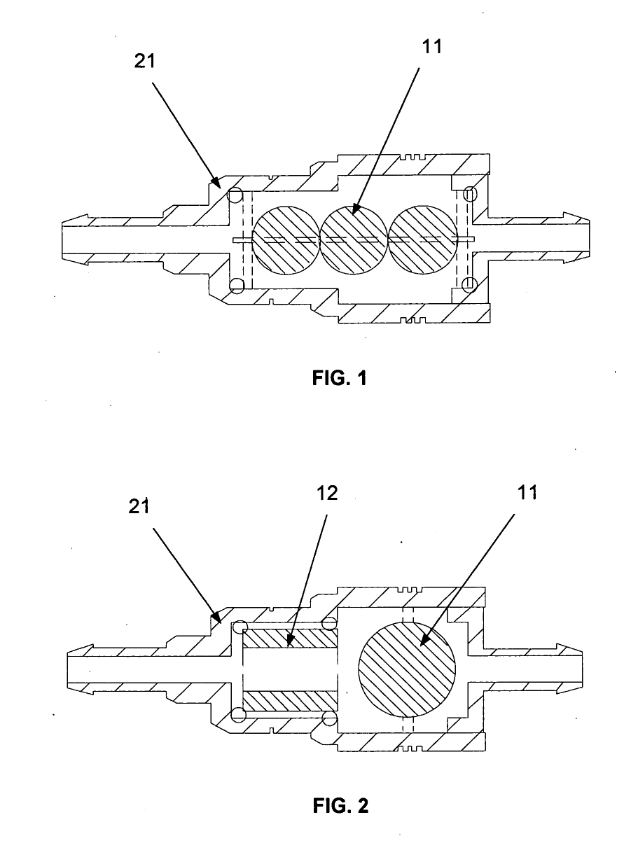

FIG. 1 shows a cutaway perspective view of one embodiment of the present invention, in which an infrared emitting body consisting of three infrared emitting balls 11 is disposed on a metal housing 21. The housing can be made of stainless steel or aluminum alloy. It can be of any convenient shape and size, while a tubular shape is preferred for the ease of inserting the device into the supply fuel line of an engine.

The infrared ray emitting units were made of a mixture of ceramic particles composed of metal oxides selected from the groups consisting of alumina, silica, zirconia, lithium oxide, magnesium oxide, calcium oxide, titanium oxide, or the like. An appropriate amount (or weight percentage) of transition metal oxides from the Group 10, such as cobalt oxide (CoO) and/or nickel oxide (NiO), are added to the said oxides mixture to enhance infrared radiation strength, particularly at wavelengths in 3-7 microns for activating stretches of certain types of valence bonds in hydrocarbon molecules of the fuels.

In FIG. 1 the metal housing 21 provides an interior compartment for holding the infrared ray emitting body. The infrared ray emitting body can consist of any number of units of infrared ray emitting element, which can be in any convenient shapes and sizes. For examples, FIG. 1 shows three infrared ray emitting balls 11 are cascaded to form an infrared emitting body, while FIG. 2 shows a combination of a tubular element 12 and a spherical element 11 in tandem to form an infrared emitting body. For the embodiments as shown in FIG. 1 and FIG. 2, the installation of the device of present invention in a fuel line requires cutting the fuel line and inserting the housing in between the cut lines.

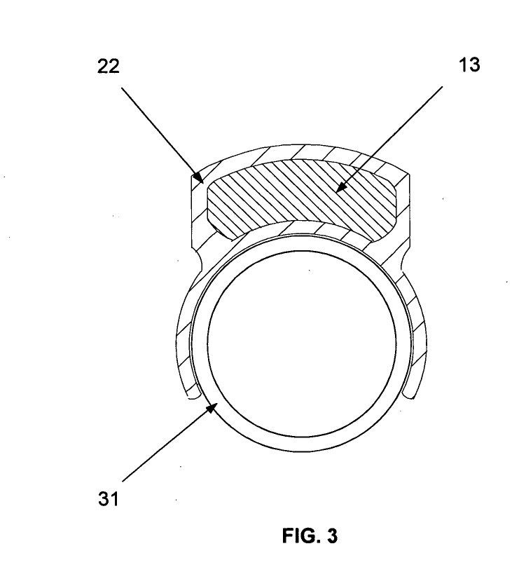

In contrast, another embodiment is shown in FIG. 3, which can be externally mounted on a non-metal fuel line 31, since infrared rays at wavelengths 3-7 microns can penetrate non-metal media, such as rubbers, plastics, glass, Teflon and so on. In this embodiment, the infrared emitting body 13 can take any arbitrary forms, but the housing 22 must be made of non-metal materials, preferably thermal-set plastics, so that the infrared rays emitted form the infrared emitting body 13 may pass through the wall of the housing 22 and also the wall of the fuel line to activate the fuel flowing beneath. The infrared emitting body 13 can consist of either a single tubular element, or pluralities of small elements, or particles disposed in the housing 22, which can take any shapes, forms, styles, patterns, and in any thickness.

### EXAMPLES

Variable weight percents of cobalt oxide were added to a commercially available infrared emitting ceramic composition made in Japan to form infrared emitting bodies. The ceramic mixture comprises alumina, silica, zirconia, lithium oxide, magnesium oxide, calcium oxide, and titanium oxide. Several test samples were made with variable weight percentage of CoO, e.g. 0 wt %, 0.2 wt %, 0.5 wt %, and 1.0 wt %. The resultant ceramic materials were formed into balls at a diameter of 16.7 mm. A set of five balls with the same CoO weight percentage were cascaded and disposed in a housing made of aluminum alloy. After comparing the results on a test diesel engine, it was found that the device of the present invention with a 0.2 wt % CoO started to improve engine performance at a noticeable level, while that with a 0.5 wt % could significantly increase the engine performance.

A prototyping device of the present invention with 0.5 wt % CoO was used to test on a 6-cylinder 5.6-liter CNG (compressed natural gas) engine. The data were taken at variable speeds while the engine was running at its full rated loads. The results are summarized in the following Tables 2 & 3. Comparing the data, It showed that with the installation of the present invention, the torques were increased by 1.8% in average, while CNG consumption rate was reduced by 17.2%. The emissions of unbumt HC and CO had also been drastically decreased by 31.9% and 94.8%, respectively.

TABLE 2
Engine performance data with OEM configuration

| Speed (rpm) | HC | CO | Torque (kg · m) | CNG Flow rate (kg/hr) |
|---|---|---|---|---|
| 1400 | 114 | 3.97 | 303 | 12.6 |
| 1600 | 116 | 4.59 | 295 | 14.1 |
| 1800 | 109 | 3.83 | 295 | 16.3 |
| 2000 | 105 | 4.10 | 290 | 17.8 |
| 2300 | 102 | 4.05 | 283 | 20.5 |

TABLE 3
Engine performance data with the device of the present invention

| Speed (rpm) | HC | CO | Torque (kg · m) | CNG Flow rate (kg/hr) |
|---|---|---|---|---|
| 1400 | 82 | 0.34 | 307 | 10.5 |
| 1600 | 80 | 0.29 | 303 | 12.0 |
| 1800 | 71 | 0.09 | 302 | 13.2 |
| 2000 | 69 | 0.15 | 296 | 14.6 |
| 2300 | 70 | 0.21 | 285 | 16.9 |

### CONCLUSION, RAMIFICATIONS, AND SCOPE

According to the present invention, an IR Fuel Activation device comprises an infrared emitting body formed of IR emitting materials containing at least 0.2 wt % cobalt oxide (CoO) that can be either inserted to or externally mounted on the fuel line of an internal combustion engine for improving the fuel combustion efficiency.

The invention has been described above. Obviously, numerous modifications and variations of the present invention are possible in light of the above teachings. Such variations are not to be regarded as a departure from the spirit and scope of the invention and all such modifications as would be obvious to one skilled in the art are intended to be included within the scope of the following claims.

1. An IR fuel activation device for contact with fuel used for an internal combustion engine for activating the fuel and for thereby achieving efficient combustion of the fuel, said engine including a fuel line, said device consisting essentially of a housing and a infrared emitting body located within said housing, said housing being mounted in said fuel line whereby fuel used for the engine passes through the housing and contacts said body and is thereby exposed to infrared emissions, said body being formed of infrared emitting oxides containing at least 0.2 wt% cobalt oxide, said cobalt oxide having a radiation capacity in the band of wavelength between 3 and 7 microns.

2. The device according to claim 1, wherein said infrared emitting body may consist of a single unit or multiple units, said unit being formed of said infrared emitting oxides.

3. The device according to claim 1, wherein said cobalt oxide is partially or fully substituted with nickel oxide.

4. An IR fuel activation device for not contacting with fuel used for an internal combustion engine for activating the fuel and for thereby achieving efficient combustion of the fuel, said engine including a fuel line, said device consisting essentially of a housing and an infrared emitting body located within said housing, said housing being mounted adjacent to and exterior of said fuel line whereby fuel in the fuel line is exposed to infrared emissions, said body being formed of infrared emitting oxides containing at least 0.2 wt% cobalt oxide, said cobalt oxide having a radiation capacity in the band of wavelength between 3 and 7 microns.

5. The device according to claim 4, wherein said infrared emitting body may consist of a single unit or multiple units, said unit being formed of said infrared emitting oxides.

6. The device according to claim 4, wherein said infrared body consists of particles, said particles being formed of said infrared emitting oxides.

7. The device according to claim 4, wherein said cobalt oxide is partially or fully substituted with nickel oxide.

8. The device according to claim 4, wherein said housing is made of non-metal materials.

9. A method for activating the fuel used for an internal combustion engine and for thereby achieving efficient combustion of the fuel, comprising:
providing a infrared emitting body, said body being formed of infrared emitting oxides containing at least 0.2 wt% cobalt oxide, said cobalt oxide having a radiation capacity in the band of wavelength between 3 and 7 microns; and
disposing said body adjacent to or in contact with said fuel.

10. The method according to claim 9, wherein in said providing step said cobalt oxide is partially or fully substituted with nickel oxide.
